(19) United States
(12) Patent Application Publication
(10) Pub. No.: US 2014/0301530 A1
(43) Pub. Date: Oct. 9, 2014

(54) PROTECTIVE SHIELD FOR X-RAY FLUORESCENCE (XRF) SYSTEM

(71) Applicants: James L. Failla, JR., Providence, RI (US); David A. Clifford, Lynnfield, MA (US); Wayne Allen Minter, Peabody, MA (US)

(72) Inventors: James L. Failla, JR., Providence, RI (US); David A. Clifford, Lynnfield, MA (US); Wayne Allen Minter, Peabody, MA (US)

(21) Appl. No.: 13/858,309

(22) Filed: Apr. 8, 2013

(51) Int. Cl. G21F 3/00; G01N 23/22

(52) U.S. Cl. CPC G21F 3/00; G01N 23/22
USPC 378/45; 250/515.1; 29/428

(57) ABSTRACT

In one embodiment, a protective shield for a spectrometer is provided. The shield includes a body and an aperture that includes a protective mesh. The protective mesh includes a high-strength, low Z material, such as an arrangement of carbon fibers. A method of fabrication and a spectrometer are disclosed.

### BACKGROUND OF THE INVENTION

1. Field of the Invention

The invention relates to an X-ray fluorescence (XRF) system, and in particular, to a protective shield for a window of the system.

2. Description of the Related Art

X-ray fluorescence (XRF) systems are widely used. XRF systems provide for rapid non-destructive analysis and identification of elemental content in a sample. While some XRF systems are used in the laboratory environment, many XRF systems are used for field analyses. For example, XRF technology is commonly used for field analyses of lead content within paint. XRF technology is also commonly used for evaluation of materials in a scrap yard. As one might imagine, XRF systems built for field use must be rugged.

Common to all implementations of XRF technology are a source of primary radiation, a detection system, and an analyzer. Exemplary sources of primary radiation include x-ray generators. However, gamma ray sources may be used as well. When deployed, the primary radiation is directed to a sample. A portion of the radiation scattered by the sample reenters the XRF system and is detected by the detection system and subsequently analyzed by the analyzer. In the case of field use equipment, the detection system and other components of the XRF system are typically protected by a thin window.

Wavelengths of radiation scattered by the various elements that may be contained within the sample are unique to each of the various elements. Accordingly, by knowing the wavelengths of characteristic radiation emissions, it is possible to determine elemental content of each sample. However, given that some elements have very low energy characteristic emissions, designers of XRF systems must do everything possible to avoid attenuation of characteristic emissions.

Accordingly, in the case of field instrumentation, the protective window is usually very thin. Minimizing density and thickness of the window supports instrument performance and detection limits in two ways. First, a thinner and less dense window will provide less attenuation of the low energy X-Ray signal returning to the detector from the sample. In addition, a thinner, less dense window is not easily excited by the primary X-Ray beam, thus resulting in a lower background fluorescence signal in the detector arising from Compton scattering.

In use, radiation emitted by the primary radiation source hits the sample and then is scattered by the sample. The radiation scattered is emitted isotropically from the sample. If a user is attempting to analyze a sample having a very low concentration of the material (such as lead contained within lead paint), then it is advantageous to place the detection system as close as possible to the sample such that the detector will be exposed to a greater portion of the scatter radiation. This frequently leads to breakage of the thin window.

What are needed are methods and apparatus for providing XRF instruments with robust physical protection of a window, while presenting a minimal interference with characteristic radiation emitted by a sample.

### SUMMARY OF THE INVENTION

In one embodiment, a protective shield for a spectrometer is provided. The shield includes a body and an aperture that includes a protective mesh. The protective mesh includes a high-strength, low Z material.

In another embodiment, a method for fabricating a protective shield for a spectrometer is provided. The method includes: configuring a body for mounting to the spectrometer; and incorporating a protective mesh that includes a high-strength, low Z material into an aperture of the body.

In yet another embodiment, an x-ray fluorescence spectrometer is provided. The spectrometer includes an opening in a housing for at least one of providing primary radiation and receiving characteristic emissions from a sample, the housing including a mount for mounting a protective shield thereon. The spectrometer also includes a protective shield mounted to the housing, the protective shield including a body and an aperture that also includes a protective mesh, the protective mesh including at least one of carbon fibers, beryllium, boron nitride, and a para-aramid synthetic fiber.

### BRIEF DESCRIPTION OF THE DRAWINGS

The features and advantages of the invention are apparent from the following description taken in conjunction with the accompanying drawings in which:

FIG. 1 is an isometric diagram of a handheld XRF system including a protective shield according to the teachings herein;

FIG. 2 is an isometric view of a prior art window bracket;

FIG. 3 is an isometric view of an uninstalled protective shield; and,

FIG. 4 is a cross-sectional view of an embodiment of the protective shield.

### DETAILED DESCRIPTION OF THE INVENTION

Disclosed herein are methods and apparatus that provide a protective shield for an x-ray fluorescence (XRF) device. Generally, the protective shield may be configured for use with a handheld or portable XRF device. Advantageously, the protective shield exhibits a low mass density thickness, and therefore causes minimal attenuation of fluorescence signals from a sample.

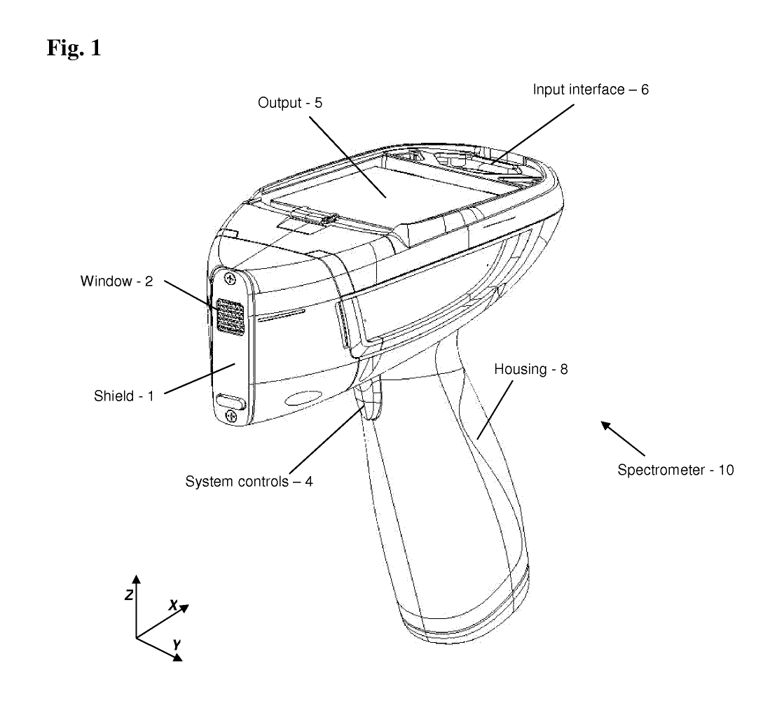

Referring now to FIG. 1, there is shown an exemplary spectrometer 10. In this example, the spectrometer 10 is an x-ray fluorescence (XRF) device. In particular, the exemplary spectrometer 10 is a handheld XRF device. While the teachings here are presented in the context of a handheld XRF device, this is merely illustrative and is not limiting. Accordingly, the protective shield and other aspects may be practiced with devices other than a handheld XRF device. Exemplary other devices include laboratory-based XRF devices.

In the exemplary embodiment depicted in FIG. 1, the handheld XRF device is contained within a housing 8. The handheld XRF device includes an input interface 6 for manipulation of the device. The input interface 6 may include at least one pushbutton, touchscreen, or other such device for adjusting settings of the spectrometer 10. A user may monitor settings of the spectrometer 10 by viewing output 5. The output 5 may include a screen, such as an LCD screen. The output 5 may further include a speaker, such as one configured to provide auditory output such as an alarm. The output 5 may include a network interface such as an Ethernet, serial, parallel, 802.11, USB, Bluetooth or other type of interface (not shown). The spectrometer 10 may include an internal power supply (e.g., a battery), memory, a processor, a clock, data storage, and other similar components. System controls 4 may include a trigger or other such device to provide for initiation of sampling and analysis with the spectrometer 10. The output 5 may provide raw data, spectral data, concentration data and other appropriate forms of data.

Also shown in FIG. 1 is an embodiment of a protective shield 1. The protective shield 1 includes an aperture that includes a protective mesh 2.

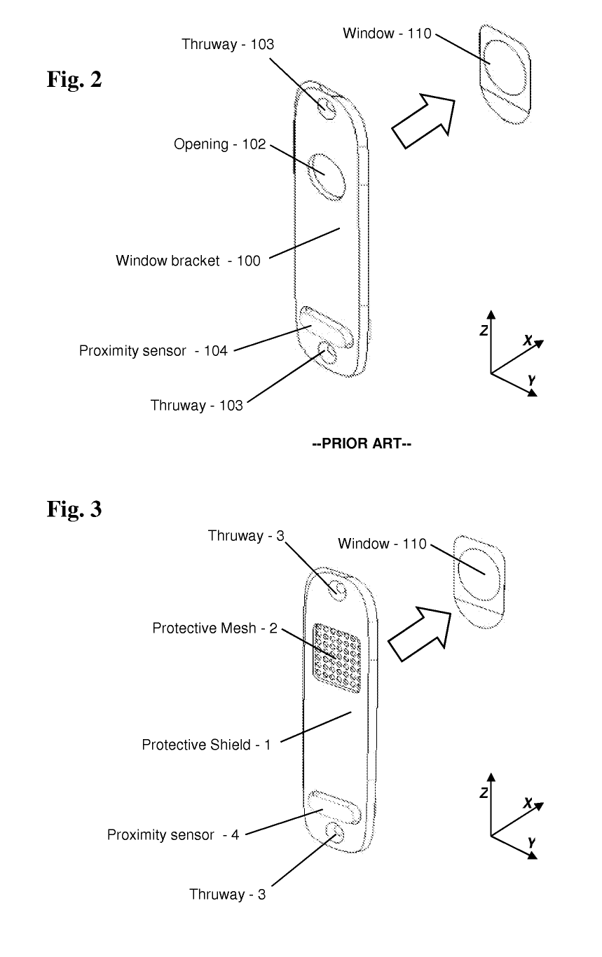

Referring now to FIG. 2, an exemplary prior art window bracket 100 is shown. A window 110 for the XRF device includes a thin film that is placed over an opening in the window bracket 100. Typically, the window 110 is a polypropylene film of a thickness of about four (4) microns. The window 110 may be adhered to the window bracket 100 by a pressure sensitive adhesive along the edges. The window bracket 100 has an opening 102 that is a single aperture to enable passage of X-Rays without attenuation. In turn, the window bracket 100 is mounted to the spectrometer 10 (XRF device). In one example, the window bracket 100 includes at least one thruway 103. Each thruway 103 may be configured to receive a screw (not shown) to screw the window bracket 100 to the spectrometer 10. In some embodiments, at least one proximity sensor 104 may be included.

As discussed above, this design is problematic. That is, in practice, a user may very often puncture the window 110 by pressing the XRF device against an irregular shaped sample. When a portion of the sample protrudes through the opening 102, it breaks the window 110. Accordingly, protecting the spectrometer 10 requires removing the window bracket 100 and replacing the window 110. This is time-consuming, costly, and risks damaging the spectrometer 10 if servicing is performed in the field.

Referring now to FIG. 3, a protective shield 1 according to the teachings herein is illustrated. In this example, the protective shield 1 is provided in the geometry that is suited for replacement of the prior art window bracket 100. That is, the protective shield 1 may have a shape and size that is similar to the prior art window bracket 100. Additionally, the protective shield 1 may include at least one thruway 3. Each thruway 3 may be configured to receive a screw (not shown) to screw the protective shield 1 to the spectrometer 10. In some embodiments, at least one proximity sensor 4 may be included.

The protective shield 1 includes a protective mesh 2 disposed in an aperture of the protective shield 1. In this example, the protective mesh 2 is fabricated from carbon fiber. Use of carbon fiber provides a high strength barrier to protect the window 110 from physical damage.

During fabrication, the protective mesh 2 may be fabricated with substantially continuous fibers orthogonally oriented in a layup of 0 degrees and 90 degrees. The layup may include a plurality of layers of the carbon fibers. By bundling and spacing of the carbon fibers in the layup, a regular pattern of holes results in the protective mesh 2. By incorporation of the protective mesh 2, the protective shield 1 limits or prevents damage of the window 110.

The at least one proximity sensor 4 may be sized to provide for adequate standoff from a sample, to enhance physical strength of the protective shield and, in some embodiments, may be omitted from the protective shield 1. In some embodiments, the proximity sensor 4 must be activated prior to generation of the primary radiation. Accordingly, the proximity sensor 4 is a safety device, and may serve other functions as well.

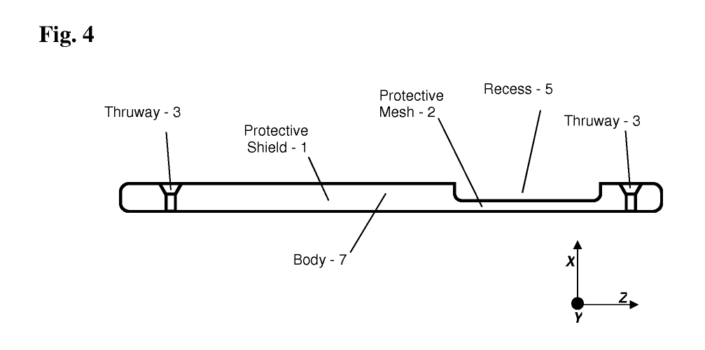

Referring now to FIG. 4, there is shown a cross-sectional view of the protective shield 1. In this example, it may be seen that the protective shield 1 includes a recess 5. The recess 5 may provide for an implementation of a comparatively thin protective mesh 2. That is, it may be considered that a cross-section of the protective mesh 2 is thin in comparison to a cross-section of a body 7 of the protective shield 1.

Accordingly, the protective shield 1 exhibits a relatively high strength and low mass density thickness, thus minimizing interference with the x-ray source, as well as characteristic emissions from a sample.

Generally, the protective mesh 2 may be characterized as a structure made of strands of carbon fiber with evenly spaced openings between them. However, it is not required that the protective mesh 2 have evenly spaced openings. Nor is it required that the protective mesh 2 be fabricated entirely from carbon fiber. For example, fiber in the protective mesh 2 may include some degree of impurities, and may include polymers, binders, and any other material deemed appropriate. In some embodiments, the protective mesh 2 includes materials that are “low Z” materials. That is, the protective shield 1 includes materials that are lightweight materials formed from elements having relatively few protons in the nucleus. Exemplary materials include include beryllium, boron nitride, and KEVLAR, a para-aramid synthetic fiber available from DuPont Chemical of Wilmington Del. Other materials, such as other fibers that exhibit desirable properties may be used in the protective shield 1.

In some embodiments, the protective mesh 2 includes a weave of fibers (and thus exhibit an appearance similar to that of a woven screen). Generally, the protective mesh 2 provides a balance of a strong physical barrier (that minimally interferes with primary or characteristic radiation) and an unabated pathway to the window 110.

A body of the protective shield 1 may be fabricated from any material deemed appropriate. In some embodiments, the body of the protective shield 1 is also fabricated from carbon fiber. In some embodiments, the body of the protective shield 1 is fabricated from a carbon fiber composite of all low density material. Generally, material selected for the body of the protective shield 1 is chosen to minimize incorporation of heavy elements and thus reducing background noise in the detection system due to Compton scattering.

A demonstration of the efficacy of detection with the protective shield one in place is provided in Table 1.

TABLE 1
Comparative Evaluation of Materials

| | Conventional Window | | Protective Shield | |
|---|---|---|---|---|
| | Properly | Matching | Properly | Matching |
| Sample Material | identified? | Factor | identified? | Factor |
| Stainless Steel 301 | Yes | 0.00 | Yes | 0.88 |
| Stainless Steel 310 | Yes | 1.28 | Yes | 0.00 |
| Stainless Steel 347 | Yes | 0.00 | Yes | 1.77 |
| Titanium Alloy 6-2-4-2 | Yes | 2.33 | Yes | 2.52 |
| 63% Sn/37% Pb Alloy | Yes | 4.37 | Yes | 3.62 |
| Hastelloy ® C-276 | Yes | 0.00 | Yes | 0.00 |
| Nickel-based Alloy | | | | |
| Nitronic ® 50 | Yes | 0.00 | Yes | 0.00 |
| Stainless Steel | | | | |
| CDA-932 High Leaded | Yes | 2.04 | Yes | 0.23 |
| Tin Bronze | | | | |
| RA333 ® High | Yes | 0.00 | Yes | 0.00 |
| Chromium Nickel Alloy | | | | |
| Nimonic ® 263 Nickel | Yes | 3.48 | Yes | 3.17 |
| Alloy | | | | |

Referring to Table 1, it may be seen that the spectrometer 10 equipped with the protective shield 1 properly identified each sample. With regards to the matching factor, smaller is better, with 0.00 being the best possible value. In short, it may be seen that the protective shield 1 does not substantially impact operability of the spectrometer 10.

It should be noted that Hastelloy, Nitronic, RA333, and Nimonic are registered trademarks, belonging to their respective owners. The CDA in CDA-932 stands for Copper Development Association, an industry trade group that has established naming conventions for copper alloys.

Having introduced the protective shield 1, some aspects of additional embodiments are provided.

The protective shield 1 may be provided as equipment for retrofit of an existing spectrometer 10, or as an original equipment manufacturer's component.

In some embodiments, the protective shield 1 includes a plurality of apertures protected with protective meshes 2. For example, in some embodiments, a particular spectrometer 10 may have a primary window for providing primary radiation and another window for receiving characteristic radiation.

Fibers incorporated into the protective mesh 2 may have a different orientation. For example, the fibers may be oriented at 0 degrees, 30 degrees, 60 degrees and 90 degrees (i.e., the fibers may have an angular orientation). It should be considered that angles of orientation presented herein are general and not to be considered with great deal of precision or accuracy. That is, it is considered that fibers included in the protective mesh 2 may include some level of disarray as may occur in commonly produced embodiments of carbon fibers. In some embodiments, orientation of the strands of carbon fiber are random in relation to each other or “disoriented.” Generally, orientation of the carbon fibers or other fibers as may be used in the protective mesh 2 is provided in a manner the results in adequate physical strength for use of the spectrometer 10 in a physically challenging environment, such as in field use.

In some embodiments, the protective mesh 2 is first fabricated as a thin layer of material, and then perforated such as by drilling into the thin layer.

The protective shield 1 is not limited to use with a hand-held spectrometer 10. Such descriptive terminology is not meant to imply limitations on use of the protective shield 1.

In some embodiments, the protective shield 1 does not include the at least one thruway 3. Some other techniques for mounting the protective shield 1 include use of embedded magnets in the protective shield 1. In these embodiments, the embedded magnets align with a magnetic portion of the housing 8 and serve to retain the protective shield 1 in place while in use and to also permit rapid installation and removal of the protective shield 1. In some embodiments, an RFID antenna is included in the protective shield 1. Use of the RFID may be used to ensure appropriate matching of each protective shield 1 with a respective spectrometer 10, and/or identify the presence of the protective shield 1 on the spectrometer 10.

In short, a variety of methods and apparatus are available for ensuring appropriate mounting and removal of the protective shield 1. Other exemplary mounting systems include use of clips, wing nuts, snaps and various other types of fasteners.

In some embodiments, performance of the spectrometer 10 is adjusted for use of the protective shield 1. That is, the spectrometer 10 may be calibrated with the protective shield 1 in place. The spectrometer 10 may also be calibrated without the protective shield 1. A user may simply adjust controls on the input interface 6 to account for use of the protective shield 1. In some embodiments, such as where magnetic mounting is provided, the spectrometer 10 may automatically identify presence of the protective shield 1. Thus, a user may be provided with a well protected spectrometer 10 and an ability to remove the protective shield 1 when appropriate, such as to increase sensitivity.

As discussed herein, the term “x-ray source” generally refers to equipment used for generation of x-rays. However, in some embodiments, an XRF device may use a gamma emitting source (in addition to or in place of the x-ray source). Generally, “x-ray” refers to electromagnetic radiation having a wavelength in the range of about 10 picometers (pm) to about 10 nanometers (nm), while “gamma rays” include electromagnetic radiation having a wavelength up to about 10 picometers (pm).

It will be appreciated that any embodiment of the present invention may have features additional to those cited. Sometimes the term “at least” is used for emphasis in reference to a feature. However, it will be understood that even when “at least” is not used, additional numbers or types of the referenced feature may still be present. The order of any sequence of events in any method recited in the present application, is not limited to the order recited. Instead, the events may occur in any order, including simultaneously, which is logically possible.

Various other components may be included and called upon for providing for aspects of the teachings herein. For example, additional materials, combinations of materials and/or omission of materials may be used to provide for added embodiments that are within the scope of the teachings herein.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A protective shield for a spectrometer, the shield comprising:
a body and an aperture comprising a protective mesh, the protective mesh comprising a high-strength, low Z material.

2. The shield as in claim 1, wherein the material comprises at least one of carbon fibers, beryllium, boron nitride, and a para-aramid synthetic fiber.

3. The shield as in claim 2, wherein the carbon fibers comprise at least one of: an arrangement of orthogonally oriented carbon fibers, and angular arrangement of carbon fibers, disoriented carbon fibers, and a plurality of layers of carbon fibers.

4. The shield as in claim 2, wherein the carbon fibers comprise at least one of: a degree of impurities, a polymer, and a binder.

5. The shield as in claim 1, wherein a design of the protective mesh provides a balance of physical strength and limited radiation interference.

6. The shield as in claim 1, wherein the protective mesh is thin in comparison to a thickness of the body.

7. The shield as in claim 1, wherein the aperture comprises a recess.

8. The shield as in claim 1, further comprising at least one thruway for mounting the shield to the spectrometer.

9. The shield as in claim 1, wherein the body further comprises at least one of: a magnet, and a radiofrequency identification (RFID) device.

10. The shield as in claim 1, wherein the spectrometer comprises an x-ray fluorescence device.

11. A method for fabricating a protective shield for a spectrometer, the method comprising:
configuring a body for mounting to the spectrometer; and
incorporating a protective mesh comprising a high-strength, low Z material into an aperture of the body.

12. The method as in claim 11, further comprising selecting a protective mesh that comprises at least one of carbon fibers, beryllium, boron nitride, and a para-aramid synthetic fiber.

13. The method as in claim 12, wherein the carbon fibers comprise at least one of: an arrangement of orthogonally oriented carbon fibers, and angular arrangement of carbon fibers, disoriented carbon fibers, and a plurality of layers of carbon fibers.

14. The method as in claim 11, wherein the configuring comprises providing an aperture in the body to align with a window of the spectrometer.

15. The method as in claim 11, further comprising incorporating at least one of a magnet and a radiofrequency identification (RFID) device into the body.

16. An x-ray fluorescence spectrometer comprising:
an opening in a housing for at least one of providing primary radiation and receiving characteristic emissions from a sample, the housing including a mount for mounting a protective shield thereon; and
a protective shield mounted to the housing, the protective shield comprising a body and an aperture comprising a protective mesh, the protective mesh comprising at least one of carbon fibers, beryllium, boron nitride, and a para-aramid synthetic fiber.

17. The spectrometer as in claim 16, configured as a hand-held device.

18. The spectrometer as in claim 16, configured for field use.

19. The spectrometer as in claim 16, configured for analysis of materials in a scrap yard.
